(19) United States
(12) Patent Application Publication
(10) Pub. No.: US 2014/0350202 A1
(43) Pub. Date: Nov. 27, 2014

(54) ACTIVATION OF CATALYTIC SYSTEMS FOR THE STEREOSPECIFIC POLYMERIZATION OF DIENES

(71) Applicants: COMPAGNIE GENERALE DES ESTABLISSEMENTS MICHELIN, Clermont-Ferrand (FR); MICHELIN RECHERCHE ET TECHNIQUE S.A., Granges-Paccot (CH)

(72) Inventors: Julien Thuilliez, Clermont-Ferrand (FR); Olivier Rolland, Clermont-Ferrand (FR)

(73) Assignees: COMPAGNIE GENERALE DES ESTABLISSEMENTS MICHELIN, Clermont-Ferrand (FR); MICHELIN RECHERCHE ET TECHNIQUE S.A., Granges-Paccot (CH)

(21) Appl. No.: 14/367,173

(22) PCT Filed: Dec. 20, 2012
(86) PCT No.: PCT/EP2012/076449

§ 371 Date: Jun. 19, 2014

(30) Foreign Application Priority Data
Dec. 22, 2011 (FR) 1162301

(51) Int. Cl. C08F 136/06

(52) U.S. Cl. CPC C08F 136/06
USPC 526/155; 526/340.4

(57) ABSTRACT

An activated preformed catalytic system for the 1,4-cis stereospecific polymerization of conjugated dienes based on at least:
one or more preformation conjugated diene monomers,
one or more salts of one or more rare-earth metals of one or more acids chosen from an organic phosphoric acid and an organic carboxylic acid, and a mixture thereof,
one or more alkylating agents consisting of one or more alkylaluminiums of formula AlR₃ or HAlR₂, in which R represents an alkyl radical and H represents a hydrogen atom,
one or more halogen donors consisting of an alkylaluminium halide, and
one or more compounds corresponding to formula (I) below:

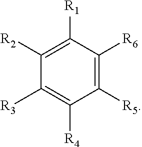

This application is a 371 national phase entry of PCT/EP2012/076449, filed 20 Dec. 2012, which claims benefit to FR 1162301, filed 22 Dec. 2011, the entire contents of which are incorporated herein by reference for all purposes.

### BACKGROUND

1. Field

The present disclosure relates to an activated catalytic system that may be used for the polymerization of diene elastomers, such as polybutadienes and polyisoprenes, and especially for the stereospecific polymerization of conjugated 1,4-cis dienes. The disclosure also relates to a process for preparing the said catalytic system, to a process for polymerizing conjugated dienes using the said catalytic system, to a process for activating the catalytic system, to the use of the said catalytic system for the stereospecific polymerization of conjugated 1,4-cis dienes and finally to the use of a compound of formula (I) for activating particular catalytic systems.

2. Description of Related Art

For the preparation of polybutadienes or polyisoprenes having a high content of cis-1,4 sequences, it is known practice to use catalytic systems based on:
a rare-earth metal salt in solution in a hydrocarbon-based solvent,
an agent for alkylating this salt, consisting of an alkylaluminium, and
an alkyaluminium halide.

It is known practice, for example, from document “Compte-rendu de l'Académie des Sciences d'U.R.S.S., volume 234, No. 5, 1977 (Y. B. Monakov, Y. R. Bieshev, A. A. Berg, S. R. Rafikov)”, to use, for the polymerization of isoprene, a catalytic system comprising:
a neodymium or praseodymium salt of bis(2-ethylhexyl)phosphoric acid, as rare-earth metal salt, in solution in toluene,
triisobutylaluminium as alkylating agent, in an (alkylating agent/rare-earth metal salt) mole ratio equal to 20, and
diethylaluminium chloride as alkylaluminium halide.

It will be noted that a small amount of diene to be polymerized, intended to prepare a preformed catalyst, is absent from this catalytic system.

Mention may also be made of the document “Proceedings of China—U.S. Bilateral Symposium on Polymer Chemistry and Physics, Science Press, pp. 382-398, 1981 (O. Jun, W. Fosong, S. Zhiquan)”. This document teaches the use of a neodymium salt of bis(2-ethylhexyl)phosphoric acid, in combination with triethylaluminium or triisobutylaluminium, and an alkylaluminium halide of formula Al₂(C₂H₅)₃Cl₃. However, it was observed that the catalytic activity of such a system is unsatisfactory.

American patent U.S. Pat. No. 3,794,604 describes in its preparation examples a catalytic system of “preformed” type in the presence of a conjugated diene monomer, comprising:
butadiene or isoprene as conjugated diene monomer,
cerium octanoate as rare-earth metal salt in solution in benzene,
diisobutylaluminium hydride as alkylating agent, in an (alkylating agent/rare-earth metal salt) mole ratio substantially equal to 20, and
ethylaluminium dichloride as alkylaluminium halide.

It will also be noted that the solvent used for the preparation of such catalysts is benzene, i.e. an unsubstituted aromatic solvent, which may pose hygiene and toxicity problems.

Japanese patent JP-A-60/23406 also describes a catalytic system of “preformed” type in the presence of butadiene, which is specifically intended for the polymerization of butadiene. The catalytic systems that were tested in the preparation examples of that document comprise:
a neodymium salt of bis(2-ethylhexyl)phosphoric acid as rare-earth metal salt in solution in n-hexane or cyclohexane,
triisobutyaluminium or diisobutylaluminium hydride as alkylating agent, in an (alkylating agent/rare-earth metal salt) mole ratio ranging from 10 to 30, and
ethylaluminium sesquichloride as alkylaluminium halide.

It will be noted that several solvents may be used, such as aliphatic or alicyclic hydrocarbons, aromatic or halogenated hydrocarbons. The advantage of preparing separately the polymerization catalyst to obtain high activities is demonstrated. However, catalytic activity of this system is insufficient.

One of the main characteristics of the various catalysts described above in the perspective of industrial application is the catalytic activity, i.e. the amount of polymer manufactured per unit of time and per mole of catalyst (more precisely per mole of rare-earth metal, i.e. neodymium). Specifically, the challenge is to succeed in manufacturing a polymer having the characteristics of choice, such as the microstructure (for example the content of 1,4-cis unit) or the macrostructure (molar mass values and distribution, presence or absence of branching), by using the smallest possible amount of catalyst (more precisely of rare-earth metal salt). Thus, any solution aimed at improving the catalytic activity of these families of catalysts without having an impact on the characteristics of the polymer is worthy of interest.

A major drawback of the known catalytic systems is that there are no simple technical solutions that do not have an impact on the characteristics of the synthesized polymer for increasing the catalytic activity for the polymerization of conjugated dienes, in particular for the homopolymerization of butadiene and for that of isoprene.

### SUMMARY

The Applicant has discovered, unexpectedly, that an activated catalytic system of “preformed” type for the 1,4-cis stereospecific polymerization of conjugated dienes based on at least:
one or more preformation conjugated diene monomers,
one or more salts of one or more rare-earth metals of one or more acids chosen from an organic phosphoric acid, an organic carboxylic acid and a mixture thereof,
one or more alkylating agents consisting of one or more alkylaluminiums of formula AlR₃ or HAlR₂, in which R represents an alkyl radical and H represents a hydrogen atom,
one or more halogen donors consisting of an alkylaluminium halide, and
one or more compounds corresponding to formula (I) below:

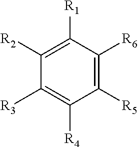

in which the groups R₁ to R₆, which may be identical or different, are chosen from a hydrogen atom, a linear or branched, saturated or unsaturated aliphatic alkyl, cycloaliphatic or aromatic radical, on condition that at least one of the groups R₁ to R₆ does not denote a hydrogen atom,
makes it possible to overcome the abovementioned drawbacks by showing an increase in the catalytic activity of the catalysts for the production of diene elastomers, such as polybutadienes and polyisoprenes.

In particular, the use of a compound corresponding to formula (I) in the preparation of the catalyst leads to an increase in the catalytic activity of the catalytic system, while at the same time conserving the characteristics of the microstructure and macrostructure of the conjugated polybutadienes obtained.

A subject of the invention, in an embodiment, is also a process for preparing the said catalytic system.

The invention, in an embodiment, also relates to a process for polymerizing diene elastomers, using the activated catalytic system according to an embodiment of the invention leading to polymers with a high content of cis-1,4 sequences.

The invention, in an embodiment, also relates to a process for activating a particular catalytic system.

A subject of the invention, in an embodiment, is also the use of the said catalytic system for the 1,4-cis stereospecific polymerization of conjugated dienes.

Finally, the invention, in an embodiment, relates to the use of compound(s) of formula (I) for activating particular catalytic systems that are useful for the 1,4-cis stereospecific polymerization of conjugated dienes.

Other subjects, characteristics, aspects and advantages of the invention will emerge even more clearly on reading the description and the examples that follow.

### DETAILED DESCRIPTION OF SPECIFIC EMBODIMENTS

Needless to say, the expression “based on” used to define the constituents of the catalytic system means the mixture of these constituents and/or the product of the reaction between these constituents.

Moreover, any range of values denoted by the expression “between a and b” represents the range of values extending from more than a to less than b (i.e. limits a and b excluded), whereas any range of values denoted by the expression “from a to b” means the range of values extending from a to b (i.e. including the strict limits a and b).

For the purposes of embodiments of the present invention, the term “catalytic system of preformed type” means a system which comprises the conjugated diene monomer to be polymerized, introduced to a proportion of from 5 to 100 molar equivalents relative to the rare-earth metal.

### Preformation Conjugated Diene Monomer

The catalytic system according to an embodiment of the present invention comprises one or more preformation conjugated diene monomers.

As conjugated diene monomers that may be used for “preforming” the catalytic system according to the invention, mention may be made of 1,3-butadiene, 2-methyl-1,3-butadiene (or isoprene), 2,3-di(C₁ to C₅ alkyl)-1,3-butadienes, for instance 2,3-dimethyl-1,3-butadiene, 2,3-diethyl-1,3-butadiene, 2-methyl-3-ethyl-1,3-butadiene, 2-methyl-3-isopropyl-1,3-butadiene, phenyl-1,3-butadiene, 1,3-pentadiene and 2,4-hexadiene, or any other conjugated diene containing between 4 and 8 carbon atoms.

Preferably, the conjugated diene monomer is chosen from butadiene, isoprene and a mixture thereof.

The mole ratio of the conjugated diene monomer to the rare-earth metal salt is less than 100, preferably not more than 80 and more preferentially 70. This ratio is preferably at least 10 and more preferentially at least 15. Thus, the mole ratio of the conjugated diene monomer to the rare-earth metal salt may be between 5 and 100, and preferably has a value ranging from 10 to 80 and even more preferentially from 15 to 70.

### Salt of One or More Rare-Earth Metals

The catalytic system according to embodiments of the present invention comprises one or more salts of one or more rare-earth metals, i.e. metals having an atomic number between 57 and 71 in the Mendeleev Periodic Table of the Elements, of an organic phosphoric or carboxylic acid.

According to embodiments of the invention, the term “rare-earth metal” means any element of the lanthanide family, yttrium or scandium. Preferentially, the rare-earth metal element is chosen from the elements yttrium, neodymium, gadolinium and samarium, and more preferentially neodymium or gadolinium.

According to embodiments of the invention, the catalytic system according to an embodiment of the present invention comprises one or more salts of one or more rare-earth metals of one or more acids chosen from an organic phosphoric acid, an organic carboxylic acid and a mixture thereof. According to a particular embodiment of the invention, the salt of one or more rare-earth metals is an organic phosphoric acid of this or these rare-earth metals.

When the salt is a carboxylate, it is chosen from linear or branched aliphatic carboxylic acid esters containing 6 to 20 carbon atoms in the linear chain, and aromatic carboxylic acid esters comprising between 6 and 12 carbon atoms, substituted with a C₁ to C₉ alkyl group or unsubstituted. Examples that may be mentioned include neodecanoate (versatate), octanoate, hexanoate, linear or branched, or alternatively naphthenate, substituted with a C₁ to C₉ alkyl group or unsubstituted. Among the carboxylate family, the salt is preferably a rare-earth metal 2-ethylhexanoate, naphthenate or neodecanoate.

When the salt is chosen from organophosphates, it comprises the phosphoric acid diesters of general formula (RₐO)(R_{b}O)PO(OH), in which Rₐ and R_{b}, which may be identical or different, represent a linear or branched, saturated or unsaturated alkyl radical, containing 6 to 20 carbon atoms in the linear chain, aryl or alkylaryl radical, optionally interrupted with one or more heteroatoms, such as oxygen. Among these phosphoric acid diesters, Rₐ and R_{b}, which may be identical or different, are preferably an n-butyl, isobutyl, pentyl, amyl, isopentyl, 2,2-dimethylhexyl, 1-ethylhexyl, 2-ethylhexyl, tolyl or nonaphenoxyl radical.

Among the organophosphate family, the salt is preferably a rare-earth metal tris[bis(2-ethylhexyl)phosphate].

According to a preferential implementation example of the invention, the salt of one or more rare-earth metals is chosen from tris[bis(2-ethylhexyl)phosphate], tris(versatate), and a mixture thereof of the said rare-earth metal(s).

Even more preferentially, the said rare-earth metal salt is chosen from neodymium tris[bis(2-ethylhexyl)phosphate] and neodymium tris(versatate), and a mixture thereof.

The rare-earth metal salt may be in the form of a powder, a solution in an inert hydrocarbon-based solvent, a suspension in an inert hydrocarbon-based solvent or even a gel in an inert hydrocarbon-based solvent, depending on the nature of the salt and of its substituents.

According to one embodiment of the invention, the rare-earth metal salt may be in the form of a non-hygroscopic powder having a slight tendency to agglomerate at room temperature.

According to a second embodiment of the invention, when the rare-earth metal salt is suspended in an inert hydrocarbon-based solvent, this solvent is an aliphatic or alicyclic solvent of low molecular weight, such as pentane, isopentane, a mixture of pentanes, a C₅ fraction, isoamylenes, hexane, a mixture of hexanes, cyclohexane, methylcyclohexane, n-heptane, a mixture of heptanes, or a mixture of these solvents.

According to another embodiment of the invention, the solvent used for the suspension of the rare-earth metal salt may be a mixture of a high molecular weight aliphatic solvent comprising a paraffinic oil, for example liquid petroleum jelly, and a low molecular weight solvent such as those mentioned above (for example cyclohexane or methylcyclohexane). This suspension is prepared by performing a dispersive grinding of the rare-earth metal salt in a paraffinic oil, so as to obtain a very fine and homogeneous suspension of the salt.

According to a preferential embodiment of the invention, the solvent used to prepare the suspension, the gel or the solution of the rare-earth metal salt corresponds to formula (I) described above.

Preferably, the catalytic system according to an embodiment of the invention has a molar concentration of rare-earth metal salt of between 0.005 mol/L and 0.100 mol/L, preferably ranging from 0.010 to 0.080 mol/L and even more preferentially from 0.020 to 0.060 mol/L.

### Alkylating Agent

The catalytic system according to embodiments of the present invention comprises one or more alkylating agents.

As alkylating agent that may be used in the catalytic system according to an embodiment of the invention, mention may be made of alkylaluminiums of formula AlR₃ or HAlR₂, in which R represents a linear or branched, saturated alkyl radical and H represents a hydrogen atom.

Preferably, the group R denotes a C₁-C₈ alkyl group and more particularly an n-propyl, isopropyl, n-butyl and isobutyl group.

Alkylaluminiums such as:
trialkylaluminiums, the alkyl radical being C₂-C₈, for example triethylaluminium, triisobutylaluminium or trioctylaluminium, or
dialkyaluminium hydrides, the alkyl radical being C₂-C₄, for example diisobutylaluminium hydride, may be mentioned.

It will be noted that this alkylating agent is preferably diisobutylaluminium hydride.

The mole ratio of the alkylating agent to the rare-earth metal salt may be between 2 and 50, preferably between 3 and 20 and even more preferentially ranging from 4 to 10, since less alkylating agent is thus used, which is an indisputable economic advantage in terms of consumption of reagents.

### Halogen Donor

The catalytic system according to embodiments of the present invention comprises one or more halogen donors consisting of an alkylaluminium halide.

As halogen donors that may be used in the catalytic system according to an embodiment of the present invention, mention may be made of alkylaluminium halides, the linear or branched, saturated alkyl radical being C₂-C₄ and the halogen being chlorine or bromine.

Preferably, the halogen donor is chosen from diethylaluminium chloride, diethylaluminium bromide, ethylaluminium dichloride or ethylaluminium sesquichloride.

Preferably, the halogen donor is diethylaluminium chloride.

The mole ratio of the halogen donor to the rare-earth metal salt may be between 0.5 and 5.0, preferably between 2.0 and 3.6 and even more preferentially between 2.5 and 3.2.

### Aromatic Compound

The catalytic system according to embodiments of the present invention comprises one or more compounds corresponding to formula (I) below:

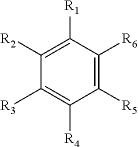

in which the groups R₁ to R₆, which may be identical or different, are chosen from a hydrogen atom, a saturated or unsaturated, linear or branched aliphatic alkyl, cycloaliphatic or aromatic radical, on condition that at least one of the groups R₁ to R₆ does not denote a hydrogen atom.

Preferably, at least one of the groups R₁ to R₆ is a saturated or unsaturated, linear or branched aliphatic alkyl radical.

Two or more of the groups R₁ to R₆ may be linked together so as to form an additional ring, such as a ring containing 5 carbon atoms, such as a cyclopentadiene, or an aromatic or non-aromatic ring containing 6 carbon atoms.

By way of examples, the compounds of formula (I) are chosen from toluene, pentylbenzene, 1,4-dimethylbenzene, indene, 2-methylindene, 2-ethylindene, 2-propylindene, 1-benzylindene, 2-phenylindene, 1,1,5-trimethylindene, fluorene, naphthalene, anthracene and phenanthrene bearing an alkyl substituent, and a mixture thereof.

Preferably, the compound of formula (I) is chosen from toluene, pentylbenzene and 1,4-dimethylbenzene, and a mixture thereof.

The mole ratio of the compound of formula (I) to the rare-earth metal salt may be between 5 and 1000, preferably ranging from 50 to 500 and even more preferentially from 100 to 400.

### Solvents for the Catalytic System

The catalytic system thus prepared may be used in an inert hydrocarbon-based solvent. This solvent is a low molecular weight aliphatic or alicyclic solvent, such as cyclohexane, methylcyclohexane, n-heptane, or a mixture of these solvents. Methylcyclohexane is preferably used.

According to a first embodiment of the invention, the solvent for the catalytic system is the solvent used to prepare the solution, the suspension or else the gel of the rare-earth metal salt described above.

According to a second embodiment of the invention, the compound of formula (I) constitutes the solvent for the catalytic system and is then used to prepare the solution, the suspension or else the gel of the rare-earth metal salt described above. Preferably, according to this embodiment, the catalytic system does not comprise any solvents other than the compound of formula (I).

According to a third embodiment of the invention, the solvent for the catalytic system is a mixture of compound of formula (I) and of aliphatic solvent.

Thus, the solvent for the catalytic system may be chosen from cyclohexane, methylcyclohexane, n-heptane, toluene, pentylbenzene and 1,4-dimethylbenzene, and a mixture thereof.

It has been observed that catalytic systems comprising a compound of formula (I) have higher catalytic activity than those of similar catalytic systems not containing this compound of formula (I), while at the same time maintaining similar micro- and macrostructures.

### Preparation Process

A subject of the invention, in an embodiment, is also a process for preparing the said catalytic system, comprising the following successive steps:
in a first step, preparing a suspension or solution or gel of the said rare-earth metal salt as defined above in a solvent, optionally comprising the said compound of formula (I),
if the solvent does not comprise the compound of formula (I), adding the said compound corresponding to formula (I) as defined above, and then
in a second step, adding to the mixture obtained in the proceeding step one or more preformation conjugated diene monomers as defined above, and then
in a third step, adding one or more alkylating agents as defined above to the mixture obtained in the preceding step to obtain an alkylated salt, and
in a fourth step, adding one or more halogen donors to the alkylated salt obtained in the preceding step.

Preferably, the first step of placing the rare-earth metal salt in contact with a hydrocarbon-based solvent optionally containing one or more compounds of formula (I) is performed at a temperature of between 15 and 100° C., and lasts for between 1 minute and 24 hours and more preferentially between 2 minutes and 120 minutes.

Preferably, the second step of addition of the conjugated diene monomer to the mixture obtained in the first step is performed at a temperature of between 15 and 100° C. and lasts for less than 1 minute.

Preferably, the third step of addition of the alkylaluminium to the mixture obtained in the second step is performed at a temperature of between 15 and 100° C., and lasts for between 3 and 120 minutes. Preferably, the fourth step of addition of the halogen donor to the alkylated salt in the mixture obtained in the third step is performed at a temperature of between 15 and 100° C., and lasts for between 3 and 120 minutes.

Possible variants of the process for preparing the activated catalytic system according to the invention consist in inverting the first two steps mentioned above. In any case, it is important to have contact of the rare-earth metal salt with compound (I) before any contact with the alkylating agent.

### Polymerization Process

The invention, in an embodiment, also relates to a process for synthesizing diene elastomers, which consists in polymerizing in an inert hydrocarbon-based solvent the diene monomer(s) in the presence of a catalytic system as defined above.

The diene elastomer obtained may be any homopolymer or copolymer obtained by homopolymerization or copolymerization of a conjugated diene monomer containing from 4 to 12 carbon atoms.

Conjugated diene monomers that are suitable for use are especially 1,3-butadiene, isoprene, 2,3-bis(C₁ to C₅ alkyl)-1,3-butadienes, for instance 2,3-dimethyl-1,3-butadiene, 2,3-diethyl-1,3-butadiene, 2-methyl-3-ethyl-1,3-butadiene, 2-methyl-3-iospropyl-1,3-butadiene, an aryl-1,3-butadiene, 1,3-pentadiene and 2,4-hexadiene.

The diene elastomer obtained via the polymerization process according to an embodiment of the invention is characterized by a high content of cis-1,4 sequences.

Preferably, the activated catalytic system according to an embodiment of the invention is used for the polymerization of polybutadiene (BR) or polyisoprene (IR).

The polymerization is performed in a manner that is known per se, preferably in the presence of an inert hydrocarbon-based solvent which may be, for example, an aliphatic or alicyclic hydrocarbon such as pentane, hexane, heptane, isooctane, cyclohexane, methylcyclohexane, or an aromatic hydrocarbon such as benzene, toluene or xylene.

The polymerization may be formed continuously or in batch form. The polymerization is generally performed at a temperature of between 20° C. and 120° C. and preferably in the region of 30° C. to 110° C.

Advantageously, and in comparison with a process using a catalytic system not comprising a compound of formula (I), the process according to the invention makes it possible to obtain, with improved catalytic activity, a diene elastomer characterized by a high content of cis-1,4 sequences, and by a controlled molecular mass distribution, as shown by the examples which follow. This elastomer may consist, for example, of a polyisoprene (IR) or a polybutadiene (BR).

These contents of cis-1,4 sequences are measured both according to the carbon-13 nuclear magnetic resonance technique and according to the technique of assaying by infrared, which fall within a range greater than 96% and preferably of at least 96.5%.

According to implementation variants of the catalytic polymerization process in accordance with the invention, the polymerization medium may be supplemented, independently of the introduction of the catalytic system used for the polymerization reaction, with an additional predetermined amount of at least one alkylaluminium compound of formulas AlR₃ and HAlR₂ or R″ₙAlR′₃₋ₙ, in which R and R′ represent a saturated or unsaturated alkyl group of 1 to 20 carbon atoms, preferentially of 1 to 12 carbon atoms, R″ represents an allylic group, and n is an integer between 1 and 3 inclusive. Such variants are described especially in documents WO 2006/133 757, EP 1 845 118, WO 10/069 511 and WO 10/069 805. That is to say that the addition does not take place in the polymerization medium at the same time and, consequently, it takes place either before, or after, or partly before and partly after, relative to the introduction of the preformed catalytic system used for catalyzing the polymerization reaction.

In respect of this alkylaluminium compound added in a staggered manner, which may be identical to or different from the alkylating agent of the catalytic system, mention may be made of the alkylaluminiums as defined for the said alkylating agent.

It will be noted that this alkylating agent added in a staggered manner preferably consists of diisobutylaluminium hydride. Advantageously, the (alkylaluminium compound added in a staggered manner/alkylating agent in the catalytic system) mole ratio ranges from 1/20 to 10/1 and, according to an advantageous implementation form, ranges from 1/10 to 7/1 and more preferentially from 1/1 to 5/1.

It will be noted that the addition of the alkylaluminium compound before polymerization makes it possible to overcome fluctuations over time of the impurities due to the polymerization solvents which are recycled into the line inlet and to not penalize, as a result of these fluctuations, the activity of the catalytic system, so as to minimize the dispersion of the characteristics of the elastomer obtained, especially of the molecular masses.

### Activation Process

The invention, in an embodiment, also relates to a process for activating a catalytic system of “preformed” type for the 1,4-cis stereospecific polymerization of conjugated dienes based on at least:
one or more preformation conjugated diene monomers,
one or more salts of one or more rare-earth metals of one or more acids chosen from an organic phosphoric acid and an organic carboxylic acid, and a mixture thereof,
one or more alkylating agents consisting of one or more alkylaluminiums of formula AlR₃ or HAlR₂, in which R represents an alkyl radical and H represents a hydrogen atom,
one or more halogen donors consisting of an alkylaluminium halide, comprising a step of adding an abovementioned compound of formula (I) to the salts of one or more rare-earth metals.

For the purposes of embodiments of the present invention, the term “activating a catalytic system” means increasing the catalytic activity of the catalytic system, not containing any compound of formula (I), while at the same time maintaining the micro- and macrostructure characteristics of the synthesized polymer. Preferably, this increase may be measured by comparing the degrees of conversion of the reagents after a given time t, for example 5 minutes.

### Use

The invention, in an embodiment, also relates to the use of the said activated catalytic system for the 1,4-cis stereospecific polymerization of conjugated dienes. Finally, the invention relates, in an embodiment, to the use of a compound of formula (I) as defined above for activating a catalytic system of “preformed” type for the 1,4-cis stereospecific polymerization of conjugated dienes based on:
one or more preformation conjugated diene monomers,
one or more salts of one or more rare-earth metals of one or more acids chosen from an organic phosphoric acid and an organic carboxylic acid, and a mixture thereof,
one or more alkylating agents consisting of one or more alkylaluminiums of formula AlR₃ or HAlR₂, in which R represents an alkyl radical and H represents a hydrogen atom,
one or more halogen donors consisting of an alkylaluminium halide,
by addition of an abovementioned compound of formula (I) to the salts of one or more rare-earth metals.

The abovementioned characteristics of embodiments of the present invention, as well as others, will be understood more clearly on reading the implementation examples of the invention, which are given as non-limiting illustrations.

### EXAMPLES

### Formation of the Catalytic Systems

The catalyst systems were prepared in 250 mL “Steinie” bottles. All of these preparations were performed under an inert atmosphere of nitrogen. All the solvents (methylcyclohexane and toluene) used in these preparations are dry (sparged with nitrogen for 10 minutes) and under an inert atmosphere. All of the reagents are obtained from Sigma-Aldrich, Strem and Fluka. The diisobutylaluminium hydride and diethylaluminium chloride solutions used in the preparation of the catalytic systems A-D, I-O, E, F, P and Q were prepared in methylcyclohexane at concentrations of 1.014 and 0.500 mol·L⁻¹, respectively. The diisobutylaluminium hydride and diethylaluminium chloride solutions used in Examples G and H were prepared in methycyclohexane at concentrations of 1.014 and 0.500 mol·L⁻¹, respectively.

### Catalytic System A (Comparative)

A solution of 48.6 mL of methylcyclohexane is added to 1.55 g of neodymium tris(bis(2-ethylhexyl)phosphate) (1.4 mmol, 1 eq.). The mixture obtained is stirred at room temperature for 30 minutes and then left to stand for 12 hours to form a violet gel. 3.7 mL of butadiene (42 mmol, 30 eq.) and 8.08 mL of diisobutylaluminium hydride (8.4 mmol, 6 eq.) are successively added to this gel. The mixture obtained is stirred at 30° C. for 15 minutes. 8.12 mL of diethylaluminium chloride (4.06 mmol, 2.9 eq.) are added to the solution obtained, and the mixture obtained is stirred at 60° C. for 70 minutes to obtain an orange/brown solution with a neodymium concentration of 0.02 mol·L⁻¹.

### Catalytic System B (According to the Invention)

A solution of 48.6 mL of toluene (456 mmol, 326 eq.) is added to 1.55 g of neodymium tris(bis(2-ethylhexyl)phosphate) (1.4 mmol, 1 eq.). The mixture obtained is stirred at room temperature for 30 minutes and then left to stand for 12 hours to form a violet solvated solid suspension. 3.7 mL of butadiene (42 mmol, 30 eq.) and 8.08 mL of diisobutylaluminium hydride (8.4 mmol, 6 eq.) are successively added to this suspension. The mixture obtained is stirred at 30° C. for 15 minutes. 8.12 mL of diethylaluminium chloride (4.06 mmol, 2.9 eq.) are added to the solution obtained, and the mixture obtained is stirred at 60° C. for 70 minutes to obtain an orange/brown solution with a neodymium concentration of 0.02 mol·L⁻¹.

### Catalytic System C (Comparative)

A solution of 25.4 mL of methylcyclohexane is added to 0.78 g of neodymium tris(bis(2-ethylhexyl)phosphate) (0.7 mmol, 1 eq.). The mixture obtained is stirred at room temperature for 30 minutes and then left to stand for 12 hours to form a violet gel. 1.8 mL of butadiene (21 mmol, 30 eq.) and 2.36 mL of diisobutylaluminium hydride (2.45 mmol, 3.5 eq.) are successively added to this gel. The mixture obtained is stirred at 30° C. for 15 minutes. 4.06 mL of diethylaluminium chloride (2.03 mmol, 2.9 eq.) are added to the solution obtained, and the mixture obtained is stirred at 60° C. for 70 minutes to obtain an orange/brown solution with a neodymium concentration of 0.02 mol·L⁻¹.

### Catalytic System D (According to an Embodiment of the Invention)

A solution of 25.4 mL of toluene (239 mmol, 342 eq.) is added to 0.78 g of neodymium tris(bis(2-ethylhexyl)phosphate) (0.7 mmol, 1 eq.). The mixture obtained is stirred at room temperature for 30 minutes and then left to stand for 12 hours to form a violet solvated solid suspension. 1.8 mL of butadiene (21 mmol, 30 eq.) and 2.36 mL of diisobutylaluminium hydride (2.45 mmol, 3.5 eq.) are successively added to this suspension. The mixture obtained is stirred at 30° C. for 15 minutes. 4.06 mL of diethylaluminium chloride (2.03 mmol, 2.9 eq.) are added to the solution obtained, and the mixture obtained is stirred at 60° C. for 70 minutes to obtain an orange/brown solution with a neodymium concentration of 0.02 mol·L⁻¹.

### Catalytic System E (Comparative)

A solution of 12.5 mL of methylcyclohexane is added to 3.28 mL of neodymium tris(bis(2-ethylhexyl)phosphate) gel at 0.134 mol·L⁻¹ in cyclohexane (0.44 mmol, 1 eq.). The mixture obtained is stirred at room temperature for 30 minutes and then left to stand for 12 hours to form a violet gel. 1.1 mL of butadiene (13.2 mmol, 30 eq.) and 2.6 mL of diisobutylaluminium hydride (2.6 mmol, 6 eq.) are successively added to this gel. The mixture obtained is stirred at 30° C. for 15 minutes. 2.4 mL of diethylaluminium chloride (1.28 mmol, 2.9 eq.) are added to the solution obtained, and the mixture obtained is stirred at 60° C. for 70 minutes to obtain a translucent brown solution with a neodymium concentration of 0.02 mol·L⁻¹.

### Catalytic System F (According to an Embodiment of the Invention)

A solution of 12.5 mL of toluene (117 mmol, 266 eq.) is added to 3.28 mL of neodymium tris(bis(2-ethylhexyl)phosphate) gel at 0.134 mol·L⁻¹ in cyclohexane (0.44 mmol, 1 eq.). The mixture obtained is stirred at room temperature for 30 minutes and then left to stand for 12 hours to form a violet gel. 1.1 mL of butadiene (13.2 mmol, 30 eq.) and 2.6 mL of diisobutylaluminium hydride (2.6 mmol, 6 eq.) are successively added to this gel. The mixture obtained is stirred at 30° C. for 15 minutes. 2.4 mL of diethylaluminium chloride (1.28 mmol, 2.9 eq.) are added to the solution obtained, and the mixture obtained is stirred at 60° C. for 70 minutes to obtain a translucent brown solution with a neodymium concentration of 0.02 mol·L⁻¹.

### Catalytic System G (Comparative)

A solution of 22 mL of methylcyclohexane is added to 1.58 mL of neodymium tris(versatate) at 0.506 mol·L⁻¹ in hexane (0.80 mmol, 1 eq.). The mixture obtained is stirred at room temperature for 30 minutes and then left to stand for 12 hours to form a violet gel. 2 mL of butadiene (24 mmol, 30 eq.) and 9.50 mL of diisobutylaluminium hydride (9.63 mmol, 12 eq.) are successively added to this gel. The mixture obtained is stirred at 30° C. for 15 minutes. 4.65 mL of diethylaluminium chloride (2.33 mmol, 2.9 eq.) are added to the solution obtained, and the mixture obtained is stirred at 60° C. for 70 minutes to obtain a translucent brown solution with a neodymium concentration of 0.02 mol·L⁻¹.

### Catalytic System H (According to an Embodiment of the Invention)

A solution of 22 mL of toluene (206 mmol, 258 eq.) is added to 1.58 mL of neodymium tris(versatate) at 0.0506 mol·L⁻¹ in hexane (0.80 mmol, 1 eq.). The mixture obtained is stirred at room temperature for 30 minutes and then left to stand for 12 hours to form a violet gel. 2 mL of butadiene (24 mmol, 30 eq.) and 9.50 mL of diisobutylaluminium hydride (9.63 mmol, 12 eq.) are successively added to this gel. The mixture obtained is stirred at 30° C. for 15 minutes. 4.65 mL of diethylaluminium chloride (2.33 mmol, 2.9 eq.) are added to the solution obtained, and the mixture obtained is stirred at 60° C. for 70 minutes to obtain a translucent brown solution with a neodymium concentration of 0.02 mol·L⁻¹.

### Catalytic System I (According to an Embodiment of the Invention)

A solution consisting of 22.8 mL of methylcyclohexane and 1 mL of toluene (9.4 mmol, 13 eq.) is added to 0.78 g of neodymium tris(bis(2-ethylhexyl)phosphate) (0.7 mmol, 1 eq.). The mixture obtained is stirred at room temperature for 30 minutes and then left to stand for 12 hours to form a violet clear gel. 1.8 mL of butadiene (21 mmol, 30 eq.) and 4.04 mL of diisobutylaluminium hydride (4.2 mmol, 6 eq.) are successively added to this gel. The mixture obtained is stirred at 30° C. for 15 minutes. 4.06 mL of diethylaluminium chloride (2.03 mmol, 2.9 eq.) are added to the solution obtained, and the mixture obtained is stirred at 60° C. for 70 minutes to obtain an orange/brown solution with a neodymium concentration of 0.02 mol·L⁻¹.

### Catalytic System J (According to an Embodiment of the Invention)

A solution consisting of 18.8 mL of methylcyclohexane and 5 mL of toluene (46.9 mmol, 67 eq.) is added to 0.78 g of neodymium tris(bis(2-ethylhexyl)phosphate) (0.7 mmol, 1 eq.). The mixture obtained is stirred at room temperature for 30 minutes and then left to stand for 12 hours to form a violet clear gel. 1.8 mL of butadiene (21 mmol, 30 eq.) and 4.04 mL of diisobutylaluminium hydride (4.2 mmol, 6 eq.) are successively added to this gel. The mixture obtained is stirred at 30° C. for 15 minutes. 4.06 mL of diethylaluminium chloride (2.03 mmol, 2.9 eq.) are added to the solution obtained, and the mixture obtained is stirred at 60° C. for 70 minutes to obtain an orange/brown solution with a neodymium concentration of 0.02 mol·L⁻¹.

### Catalytic System K (According to an Embodiment of the Invention)

A solution consisting of 13.8 mL of methylcyclohexane and 10 mL of toluene (93.9 mmol, 134 eq.) is added to 0.78 g of neodymium tris(bis(2-ethylhexyl)phosphate) (0.7 mmol, 1 eq.). The mixture obtained is stirred at room temperature for 30 minutes and then left to stand for 12 hours to form a violet clear gel. 1.8 mL of butadiene (21 mmol, 30 eq.) and 4.04 mL of diisobutylaluminium hydride (4.2 mmol, 6 eq.) are successively added to this gel. The mixture obtained is stirred at 30° C. for 15 minutes. 4.06 mL of diethylaluminium chloride (2.03 mmol, 2.9 eq.) are added to the solution obtained, and the mixture obtained is stirred at 60° C. for 70 minutes to obtain an orange/brown solution with a neodymium concentration of 0.02 mol·L⁻¹.

### Catalytic System L (According to an Embodiment of the Invention)

11.8 mL of methylcyclohexane and 11.8 mL of toluene (111 mmol, 159 eq.) are successively added to 0.78 g of neodymium tris(bis(2-ethylhexyl)phosphate) (0.7 mmol, 1 eq.). The mixture obtained is stirred at room temperature for 30 minutes and then left to stand for 12 hours to form a clear viscous solution. 1.8 mL of butadiene (21 mmol, 30 eq.) and 4.04 mL of diisobutylaluminium hydride (4.2 mmol, 6 eq.) are then successively added. The mixture obtained is stirred at 30° C. for 15 minutes. 4.06 mL of diethylaluminium chloride (2.03 mmol, 2.9 eq.) are added to the solution obtained, and the mixture obtained is stirred at 60° C. for 70 minutes to obtain an orange/brown solution with a neodymium concentration of 0.02 mol·L⁻¹.

### Catalytic System M (According to an Embodiment of the Invention)

11.8 mL of toluene (111 mmol, 159 eq.) and 11.8 mL of methylcyclohexane are successively added to 0.78 g of neodymium tris(bis(2-ethylhexyl)phosphate) (0.7 mmol, 1 eq.). The mixture obtained is stirred at room temperature for 30 minutes and then left to stand for 12 hours to form a clear gel. 1.8 mL of butadiene (21 mmol, 30 eq.) and 4.04 mL of diisobutylaluminium hydride (4.2 mmol, 6 eq.) are successively added to this gel. The mixture obtained is stirred at 30° C. for 15 minutes. 4.06 mL of diethylaluminium chloride (2.03 mmol, 2.9 eq.) are added to the solution obtained, and the mixture obtained is stirred at 60° C. for 70 minutes to obtain an orange/brown solution with a neodymium concentration of 0.02 mol·L⁻¹.

### Catalytic System N (Comparative)

A solution consisting of 14.4 mL of methylcyclohexane is added to 0.78 g of neodymium tris(bis(2-ethylhexyl)phosphate) (0.7 mmol, 1 eq.). The mixture obtained is stirred at room temperature for 30 minutes and then left to stand for 12 hours to form a violet gel. 1.8 mL of butadiene (21 mmol, 30 eq.) and 4.04 mL of diisobutylaluminium hydride (4.2 mmol, 6 eq.) are successively added to this gel. The mixture obtained is stirred at 30° C. for 15 minutes. 5 mL of methylcyclohexane and 4.06 mL of diethylaluminium chloride (2.03 mmol, 2.9 eq.) are added successively to the solution obtained, and the mixture obtained is stirred at 60° C. for 70 minutes to obtain an orange/brown solution with a neodymium concentration of 0.02 mol·L⁻¹.

### Catalytic System O (According to an Embodiment of the Invention)

A solution consisting of 14.4 mL of methylcyclohexane is added to 0.78 g of neodymium tris(bis(2-ethylhexyl)phosphate) (0.7 mmol, 1 eq.). The mixture obtained is stirred at room temperature for 30 minutes and then left to stand for 12 hours to form a clear violet gel. 1.8 mL of butadiene (21 mmol, 30 eq.) and 4.04 mL of diisobutylaluminium hydride (4.2 mmol, 6 eq.) are successively added to this gel. The mixture obtained is stirred at 30° C. for 15 minutes. 5 mL of toluene and 4.06 mL of diethylaluminium chloride (2.03 mmol, 2.9 eq.) are added to the solution obtained, and the mixture obtained is stirred at 60° C. for 70 minutes to obtain an orange/brown solution with a neodymium concentration of 0.02 mol·L⁻¹.

### Catalytic System P (According to an Embodiment of the Invention)

A solution of 15.25 mL of pentylbenzene at 2.1 mol·L⁻¹ in methylcyclohexane (32 mmol, 73 eq.) is added to 0.49 g of neodymium tris(bis(2-ethylhexyl)phosphate) (0.44 mmol, 1 eq.). The mixture obtained is stirred at room temperature for 30 minutes and then left to stand for 12 hours to form a translucent violet suspension. 1.1 mL of butadiene (13 mmol, 30 eq.) and 2.6 mL of diisobutylaluminium hydride (2.63 mmol, 6 eq.) are successively added to this suspension. The mixture obtained is stirred at 30° C. for 15 minutes. 2.4 mL of diethylaluminium chloride (1.28 mmol, 2.9 eq.) are added to the solution obtained, and the mixture obtained is stirred at 60° C. for 70 minutes to obtain a translucent brown solution with a neodymium concentration of 0.02 mol·L⁻¹.

### Catalytic System Q (According to an Embodiment of the Invention)

A solution of 15.25 mL of 1,4-dimethylbenzene (124 mmol, 282 eq.) is added to 0.49 g of neodymium tris(bis(2-ethylhexyl)phosphate) (0.44 mmol, 1 eq.). The mixture obtained is stirred at room temperature for 30 minutes and then left to stand for 12 hours to form a translucent violet suspension. 1.1 mL of butadiene (13 mmol, 30 eq.) and 2.6 mL of diisobutylaluminium hydride (2.63 mmol, 6 eq.) are successively added to this suspension. The mixture obtained is stirred at 30° C. for 15 minutes. 2.4 mL of diethylaluminium chloride (1.28 mmol, 2.9 eq.) are added to the solution obtained, and the mixture obtained is stirred at 60° C. for 70 minutes to obtain a translucent brown solution with a neodymium concentration of 0.02 mol·L⁻¹.

### Polymerizations

The polymerizations take place in prewashed and dried 250 ml “Steinie” bottles equipped with perforated capsules and a rubber septum. Each butadiene polymerization reaction is performed under an inert atmosphere (nitrogen).

### Examples A-Q

A solution of 119 ml of methylcyclohexane is placed in the reactor as polymerization solvent and then sparged with nitrogen for 10 minutes to remove the impurities. 16 mL of freshly distilled butadiene (10.4 g), 0.8 mL of a solution of diisobutylaluminium hydride at 0.072 mol·L⁻¹ in methylcyclohexane (580 μmol per 100 g of butadiene) and 1 mL of the catalytic system A to O (200 μmol of Nd per 100 g of butadiene) are successively added to this solution. The reaction mixture is then heated to 90° C. and stirred for 5 minutes. The reaction is stopped by addition of 1 mL of methanol and then antioxidized with 0.2 phr of antioxidant 6-PPD. The polymer is obtained by drying under vacuum, in the presence of a gentle stream of nitrogen (reduced pressure of 300 torr) at a temperature of 60° C. for 24 hours.

### Example B1

The protocol is identical to that described above, except that the volume of the catalytic system B is halved (100 μmol of Nd per 100 g of butadiene).

Effect of the Compound of Formula (I): Toluene as a Function of the Chemical Nature of the Neodymium Salts, their Form, and the Composition of the Catalytic Formula

| | | Form | | | % |
|---|---|---|---|---|---|
| | Nature of the | of the | Alkylating | | Conversion |
| | ligands borne | Nd | agent/Nd | Toluene/Nd | after |
| | by Nd | salt | ratio | ratio | 5 min |
| A | tris(bis(2- | Powder | 6 | 0 | 60 |
| | ethylhexyl)- | | | | |
| | phosphate | | | | |
| B | tris(bis(2- | Powder | 6 | 326 | 89 |
| | ethylhexyl)- | | | | |
| | phosphate | | | | |
| C | tris(bis(2- | Powder | 3.5 | 0 | 81 |
| | ethylhexyl)- | | | | |
| | phosphate | | | | |
| D | tris(bis(2- | Powder | 3.5 | 342 | 96 |
| | ethylhexyl)- | | | | |
| | phosphate | | | | |
| E | tris(bis(2- | Gel* | 6 | 0 | 60 |
| | ethylhexyl)- | | | | |
| | phosphate) | | | | |
| F | tris(bis(2- | Gel* | 6 | 266 | 80 |
| | ethylhexyl)- | | | | |
| | phosphate) | | | | |
| G | tris(versatate) | Solution** | 12 | 0 | 51 |
| H | tris(versatate) | Solution** | 12 | 258 | 76 |

*Neodymium tris(bis(2-ethylhexyl)phosphate] gel at 0.134 mol · L⁻¹ in cyclohexane
**Neodymium tris(versatate) solution at 0.506 mol · L⁻¹ in hexane

This table shows that the catalytic systems according to embodiments of the invention, described in Examples B, D, F and H, lead to a significant increase in catalytic activity when compared with the control tests (Examples A, C, E and G, respectively) and thus in the polymerization performance.

In particular, the use of an additive according to embodiments of the invention is efficient irrespective of the physical form of the neodymium salt used (Examples B, D and F (powder, gel)), irrespective of the ratio of alkylating agent to neodymium (Examples B and D) and irrespective of the nature of the neodymium salt (neodymium tris(bis(2-ethylhexyl)phosphate) or neodymium tris(versatate).

### Effect of the Amount of Compound of Formula (I) According to the Invention (Toluene)

| | | % Conversion |
|---|---|---|
| | Toluene/Nd | after 5 |
| Example | ratio | minutes |
| A | 0 | 60 |
| I | 13 | 69 |
| J | 67 | 75 |
| K | 134 | 87 |
| B | 326 | 89 |

This table shows that the increase in catalytic activity may be controlled and indexed to the amount of compound of formula (I) according to embodiments of the invention.

Effect of the Order of Addition Between the Aliphatic Solvent Methylcyclohexane and the Compound Toluene During the Placing in Contact of the Hydrocarbon-Based Solution with the Neodymium Salt

| | | | % Conversion |
|---|---|---|---|
| | First | Second | after |
| Example | addition* | addition** | 5 minutes |
| L | Methylcyclo- | Toluene | 82 |
| | hexane | | |
| M | Toluene | Methylcyclo- | 83 |
| | | hexane | |

*This corresponds to the placing in contact of the neodymium salt with the first constituent of the hydrocarbon-based solution.
**This corresponds to the placing in contact of the mixture derived from the placing in contact of the neodymium salt with the first constituent of the hydrocarbon-based solution with the second constituent of the hydrocarbon-based solution.

This table shows that the compound of formula (I) according to embodiments of the invention may be added before or after the addition of the hydrocarbon-based solvent used for dissolving or dispersing the neodymium salt during the preparation of the catalytic system.

### Effect Induced According to the Nature of the Compound of Formula (I)

| | | Additive/Nd | % Conversion |
|---|---|---|---|
| Example | Additive | ratio | after 5 min |
| A | — | 0 | 60 |
| P | Pentylbenzene | 73 | 70 |
| Q | 1,4- | 282 | 78 |
| | Dimethylbenzene | | |

This table shows that several types of additive according to embodiments of the invention may be used. The presence of these additives in the catalytic system leads to an improvement in the performance of the catalytic systems based on neodymium salt.

### Effect of the Neodymium Concentration in the Polymerization Medium

| | Nd Conc. | | |
|---|---|---|---|
| | (μmol per | | |
| | 100 g of | Toluene/Nd | % Conversion |
| Example | butadiene) | ratio | after 5 min |
| A | 200 | 0 | 60 |
| B1 | 100 | 326 | 75 |
| B | 200 | 326 | 90 |

This table shows that the improvement in the catalytic activity by using a compound of formula (I) according to the invention is possible irrespective of the neodymium concentration of the catalytic systems.

### Summary Table of the Macro- and Microstructures

| | Macrostructure | | | Microstructure (%) | | |
|---|---|---|---|---|---|---|
| | Mn | | | | Trans- | |
| Example | (g/mol) | Ip | Viscosity | 1.2 | 1.4 | Cis-1.4 |
| A (comp) | 105727 | 1.97 | 2.12 | 0.6 | 1.5 | 97.9 |
| B (inv) | 90712 | 2.17 | 2.06 | 0.5 | 2.6 | 96.9 |
| E (comp) | 97478 | 2.00 | 1.96 | 0.6 | 2.0 | 97.4 |
| F (inv) | 99100 | 2.14 | 2.10 | 0.5 | 2.8 | 96.7 |
| G (comp) | 83347 | 2.23 | 1.85 | 0.7 | 1.7 | 97.6 |
| H (inv) | 87927 | 3.33 | 2.57 | 0.7 | 1.7 | 97.6 |
| I (inv) | 106627 | 1.94 | nc | 0.6 | 1.6 | 97.8 |
| J (inv) | 112822 | 1.93 | nc | 0.5 | 1.6 | 97.9 |
| K (inv) | 110783 | 1.94 | nc | 0.6 | 1.7 | 97.7 |
| P (inv) | 105013 | 2.45 | 2.24 | 0.6 | 0.9 | 98.5 |
| Q (inv) | 97788 | 1.97 | 2.18 | 0.6 | 1.4 | 98.0 |
| C (comp) | 133906 | 2 | nc | 0.5 | <0.8 | 99.5 |
| D (inv) | 153856 | 2.36 | nc | 0.5 | <0.8 | 99.5 |

The addition of a compound of formula (I) according to embodiments of the invention to the catalytic system makes it possible to increase the catalytic activity of the said system. The stereospecificity of the catalyst is not penalized since the contents of 1,4-cis remain high. The macrostructure also remains similar with, possibly, a slight increase in the polydispersity index of the order of 0.1 to 0.2 point in the case of neodymium tris(bis(2-ethylhexy)phosphate).

### Measurement Methods Used

### 1. Measurement of the Inherent Viscosity

The inherent viscosity ηinh is measured at 25° C. at 0.1 g/dL in toluene and characterizes the macrostructure of the elastomer.

The viscosity is calculated via the formula

$$η = \frac{1}{C} \times ln ( \frac{{T}_{1}}{{T}_{2}} )$$

with η being the inherent viscosity (dL/g), C the concentration of polymer in toluene (g/dL), T₁ the flow time of the polymer solution (s) and T₂ the flow time of the toluene (s)).

### 2. Characterization of the Macrostructure by SEC

### a) Principle of the Measurement:

Size exclusion chromatography (SEC) makes it possible physically to separate the macromolecules according to their size in the swollen state on columns filled with porous stationary phase. The macromolecules are separated by their hydrodynamic volume, the more voluminous being eluted first.

Without being an absolute method, SEC makes it possible to assess the molecular mass distribution of a polymer. Starting with commercial calibration products, the various number-average (Mn) and weight-average (Mw) masses may be determined and the polydispersity index calculated (Ip=Mw/Mn).

### b) Preparation of the Polymer:

There is no particular treatment of the polymer sample before analysis. It is simply dissolved in tetrahydrofuran at a concentration of about 1 g/l.

### c) SEC Analysis:

Case c1): The apparatus used is a “Waters Alliance” chromatograph. The elution solvent is tetrahydrofuran, the flow rate is 1 ml/min, the system temperature is 35° C. and the analysis time is 90 min. A set of two columns of brand name “Styragel HT6E” is used.

The injected volume of the solution of the polymer sample is 100 μl. The detector is a “Waters 2140” differential refractometer and the software for processing the chromatographic data is the “Waters Millenium” system.

Case c2): The apparatus used is a “Waters, model 150C” chromatograph. The elution solvent is tetrahydrofuran, the flow rate is 0.7 ml/min, the system temperature is 35° C. and the analysis time is 90 min. A set of four columns in series, of brand names “Shodex KS807”, “Waters Styragel HMW7” and two “Waters Styragel HMW6E”, is used.

The injected volume of the solution of the polymer sample is 100 μl. The detector is a “Waters model RI32X” differential refractometer and the software for processing the chromatographic data is the “Waters Millenium” system (version 3.00).

3. Characterization of the Microstructure (Content of 1,4-cis) by Near Infrared (NIR)

The assay technique known as “near infrared” (NIR) was used. This is an indirect method using “control” elastomers, whose microstructure has been measured via the ¹³C NMR technique. The quantitative relationship (Beer-Lambert law) existing between the distribution of the monomers in an elastomer and the shape of the NIR spectrum thereof is used. This technique is performed in two steps:

### 1) Calibration:

The respective spectra of the “control” elastomers are acquired. A mathematical model associating a microstructure to a given spectrum is established, this being done by means of the PLS (partial least squares) regression method based on a factorial analysis of the spectral data. The following two documents give an in-depth treatment of the theory and implementation of this “multi-varied” data analysis method:
(1) P. Geladi and B. R. Kowalski, “Partial Least Squares-regression: a tutorial”. Analytical Chimica Acta, Vol. 185, 1-17 (1986).
(2) M. Tenenhaus, “La regression PLS—Théorie et pratique”, Paris, Editions Technip (1998).

### 2) Measurement:

The spectrum of the sample is recorded. Calculation of the microstructure is then performed.

1. An activated preformed catalytic system for the 1,4-cis stereospecific polymerization of conjugated dienes based on at least:
one or more preformation conjugated diene monomers,
one or more salts of one or more rare-earth metals of one or more acids chosen from an organic phosphoric acid, an organic carboxylic acid and a mixture thereof, the mole ratio of the conjugated diene monomer to the rare-earth metal salt being at least 10
one or more alkylating agents consisting of one or more alkylaluminiums of formula AlR₃ or HAlR₂, in which R represents an alkyl radical and H represents a hydrogen atom,
one or more halogen donors consisting of an alkylaluminium halide, and
one or more compounds corresponding to formula (I) below: 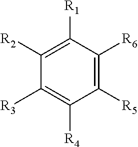
wherein the groups R₁ to R₆, which may be identical or different, are chosen from a hydrogen atom, a linear or branched, saturated or unsaturated aliphatic alkyl, cycloaliphatic or aromatic radical, on condition that at least one of the groups R₁ to R₆ does not denote a hydrogen atom.

2. The catalytic system according to claim 1, wherein the preformation conjugated diene monomer is selected from the group consisting of butadiene, isoprene, and mixtures thereof.

3. The catalytic system according to claim 1, wherein the mole ratio of the preformation conjugated diene monomer to the rare-earth metal salt has a value ranging from 10 to 80.

4. The catalytic system according to claim 1, wherein the salt of one or more rare-earth metals is in the form of a solution in an inert hydrocarbon-based solvent, a suspension in an inert hydrocarbon-based solvent or a gel in an inert hydrocarbon-based solvent, wherein the solvent corresponds to formula (I).

5. The catalytic system according to claim 1, wherein the salt of one or more rare-earth metals has a moiety that is chosen from the group consisting of tris[bis(2-ethylhexyl)phosphate], tris(versatate), and mixtures thereof.

6. The catalytic system according to claim 5, wherein the said rare-earth metal salt is selected from the group consisting of neodymium tris[bis(2-ethylhexyl)phosphate], neodymium tris(versatate), and mixtures thereof.

7. The catalytic system according to claim 1, wherein the mole concentration of rare-earth metal salt in the catalytic system is between 0.005 mol/L and 0.100 mol/L.

8. The catalytic system according to claim 1, wherein the alkylating agent is diisobutylaluminium hydride.

9. The catalytic system according to claim 1, wherein the mole ratio of the alkylating agent to the rare-earth metal salt is between 3 and 20.

10. The catalytic system according to claim 1, wherein the halogen donor is diethylaluminium chloride.

11. The catalytic system according to claim 1, wherein the mole ratio of the halogen donor to the rare-earth metal salt is between 0.5 and 10.

12. The catalytic system according to claim 1, wherein the compound of formula (I) is selected from the group consisting of toluene, pentylbenzene, 1,4-dimethylbenzene, and mixtures thereof.

13. The catalytic system according to claim 1, wherein the mole ratio of the compound of formula (I) to the rare-earth metal salt is between 5 and 1000.

14. The catalytic system according to claim 1, further comprising a solvent selected from the group consisting of cyclohexane, methylcyclohexane, n-heptane, toluene, pentylbenzene, 1,4-dimethylbenzene, and mixtures thereof.

15. A process for preparing a catalytic system as defined in claim 1, comprising, in succession:
preparing a suspension or solution or gel of the rare-earth metal salt as defined in claim 1 in a solvent, optionally comprising the compound of formula (I),
if the solvent does not comprise the compound of formula (I), adding the compound corresponding to formula (I) as defined in claim 1, to obtain a mixture, and then
adding to the mixture obtained in the preceding step one or more preformation conjugated diene monomers as defined in claim 1, and then
adding one or more alkylating agents as defined in claim 1, to the mixture obtained in the preceding step to obtain an alkylated salt, and
adding one or more halogen donors as defined in claim 1, to the alkylated salt obtained in the preceding step.

16. A process for synthesizing diene elastomers, which comprises polymerizing, in an inert hydrocarbon-based solvent, diene monomer(s) in the presence of a catalytic system as described in claim 1.

17. A process for activating a preformed catalytic system for the 1,4-cis stereospecific polymerization of conjugated dienes based on:
one or more preformation conjugated diene monomers as defined in claim 1,
one or more salts of one or more rare-earth metals of one or more acids chosen from an organic phosphoric acid and an organic carboxylic acid, and a mixture thereof, as defined in claim 1,
one or more alkylating agents consisting of one or more alkylaluminiums of formula AlR₃ or HAlR₃, in which R represents an alkyl radical and H represents a hydrogen atom, as defined in claim 1,
one or more halogen donors consisting of an alkylaluminium halide, as defined in claim 1,
comprising adding a compound of formula (I) as defined in claim 1, to the salts of one or more rare-earth metals.

18. The process according to claim 16, wherein the synthesizing of diene elastomers comprises the 1,4-cis stereospecific polymerization of conjugated dienes.

19. A method of activating a preformed catalytic system for the 1,4-cis stereospecific polymerization of conjugated dienes based on:
one or more preformation conjugated diene monomers as defined in claim 1,
one or more salts of one or more rare-earth metals of one or more acids chosen from an organic phosphoric acid and an organic carboxylic acid, and a mixture thereof, as defined in claim 1,
one or more alkylating agents consisting of one or more alkylaluminiums of formula AlR₃ or HAlR₃, in which R represents an alkyl radical and H represents a hydrogen atom, as defined in claim 1,
one or more halogen donors consisting of an alkylaluminium halide, as defined in claim 1,
by addition of a compound of formula (I) to the salts of one or more rare-earth metals: 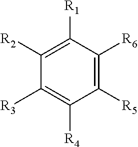
wherein the groups R₁ to R₆, which may be identical or different, are chosen from a hydrogen atom and an aliphatic alkyl, cycloaliphatic or aromatic radical, on condition that at least one of the groups R₁ to R₆ does not denote a hydrogen atom.
